(19) United States
(12) Patent Application Publication
(10) Pub. No.: US 2013/0129424 A1
(43) Pub. Date: May 23, 2013

(54) Method of constructing concrete pipelines of large diameter in an area of laying, a device for the method

(71) Applicant: Peter Gorovits, Rehovot (IL)

(72) Inventor: Peter Gorovits, Rehovot (IL)

(21) Appl. No.: 13/373,531

(22) Filed: Nov. 18, 2011

(51) Int. Cl. F16L 1/038

(52) U.S. Cl. 405/155

(57) ABSTRACT

A method of producing a concrete pipeline in an area where the pipeline is to be laid has the steps of making a trench, installing in the trench a cylindrical elastic element with a diameter equal to an inner diameter of the pipeline to be laid' placing armature on the cylindrical elastic element, pouring a liquid concrete solution on the element with the armature and hardening the concrete solution, after the hardening of the concrete solution turning a part of the element inside out, placing a reinforcing on a thusly obtained portion of the element with turned part, pouring a concrete solution again onto the portion of the element with the armature.

### BACKGROUND OF THE INVENTION

The present invention relates to methods of making pipelines, and can be used during making source to a population center or a water supply, and also in other areas when it is necessary to provide pipelines having a great diameters.

Analysis of patents and publications show that there are no original methods of manufacturing of pipelines of large diameters. An auto technology is used for this purpose which includes transporting finished pipes to an area of construction, which pipes as a rule are steel pipes provided with concrete. Then, a trench of a desired depth is digged, the pipes are installed, centered, and their ends are connected, the places of joints are provided with concrete, and the trench is closed. This technology is not highly efficient, especially for laying pipelines of large diameters due to difficulties and high cost of pipes with large diameters, their storage, providing concrete on the joints especially inside the pipe, etc.

One relatively efficient invention in this area is disclosed in SU 639,728 for a “Device for Forming Tubular Articles”. In accordance with this invention, an elastic forming element is located inside a rigid casing. This solution has been widely used in the former Soviet Union for manufacturing of tubular articles of a relatively small diameters and limited lengths.

In accordance with the technology disclosed in FR 2889817, an elastic cylindrical balloon is introduced inside the casing and inflated. Then, in a gap between the casing and the balloon a concrete is poured. After hardening of the concrete, the air from the balloon is withdrawn and it is removed from the finished product. Substantially the same technology is used nowadays for manufacture of concrete pipes in a relatively large diameter and a limited length in Western Europe.

### SUMMARY OF THE INVENTION

Accordingly, it is an object of the present invention to provide a method of constructing concrete pipelines of large diameters in an area of laying a device for the method, which eliminates the disadvantages of the prior art.

More particularly, it is an object of the present invention to provide a method of constructing concrete pipelines of large diameters in an area of laying a device for the method which allows to make a pipeline with a large diameter fast, efficient and significantly less expensive directly including in the field.

In keeping with these objects and with others which will become apparent hereinafter, one feature of the present invention resides, briefly stated in a method of producing a concrete pipeline in an area where the pipeline is to be laid, comprising the steps of making a trench; installing in the trench a cylindrical elastic element with a diameter equal to an inner diameter of the pipeline to be laid' placing armature on said cylindrical elastic element; pouring a liquid concrete solution on said element with said armature and hardening the concrete solution; after the hardening of the concrete solution turning a part of said element inside out; placing a reinforcing on a thusly obtained portion of said element with turned part; pouring a concrete solution again onto said portion of said element with said armature.

Another feature of the present invention resides, briefly stated, in placing along an axial line of said element a cable formed as a closed cable or placing along an axial line of said element a cable formed as an open cable whose length is increasable.

Still a further feature of present invention resides in a cylindrical elastic element for making a concrete pipeline and installable and a trench, wherein said cylindrical elastic element has a diameter selected to be equal to an inner diameter of the pipeline to be laid and is provided with an armature on it, with concrete produced by hardening of a liquid concrete solution poured on the element with the armature, with a part of the element with the armature turned inside out, with an armature on a portion of the element formed this way, and with a concrete produced by pouring of a concrete solution on said portion of said element with the armature.

An additional feature of the present invention resides in a closed cable arranged along the axial line of the element and a cable arranged along an axial line of the element and having a length which is increasable.

When the method is performed and a device is designed in accordance with the present invention, it is no longer necessary to transport pipes of large diameter to the area of laying of pipeline, to cement them, to connect them with one another, to cover joints with concrete, etc.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a method of constructing a concrete pipeline of a large diameter in accordance with a first embodiment of the present invention;

FIG. 2 shows a method of constructing a concrete pipeline of a large diameter in accordance with a first embodiment of the present invention in accordance with another embodiment of the present invention; and

FIG. 3 is a cross-section of the pipeline in the process of its construction.

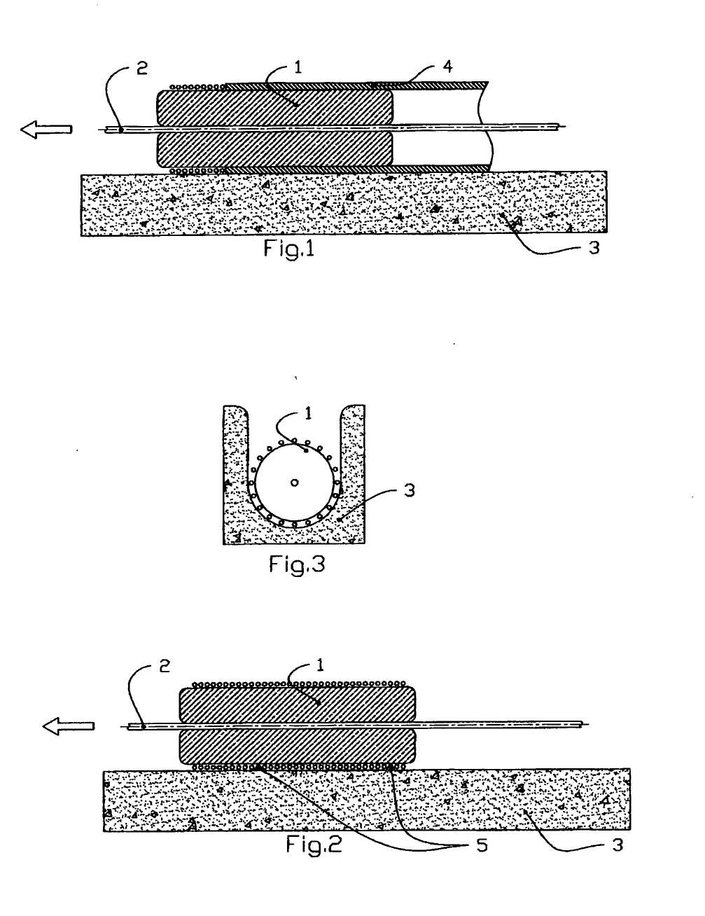

### DESCRIPTION OF THE PREFERRED EMBODIMENTS

For the inventive method of erecting a concrete pipeline of a large diameter, an element 1 is provided, which is formed in an elastic polymeric material and has a cylindrical shape. The element 1 has an outer diameter which is equal to an inner diameter to be constructed. A metallic cable is provided along an axial line of the element 1.

The above mentioned cylindrical elastic element 1 is utilized in the inventive method of constructing of a concrete pipeline with a large diameter.

In order to start construction of a pipeline, at least two embodiments are possible. In accordance with the first embodiment, a trench is provided, a pipe 4 having a desired diameter is arranged in the trench 3, and the cylindrical elastic element 1 is arranged in the piece of pipe 4. Then with the use of any pulling means, such as a tractor, a tract, etc., a cable 2 is pulled from the element 1. During this process, due to adhesion of the material of the cable 2 to the elastic material of the element 1, the element 1 is turned from inside out, and moves partially from the previously installed piece pipe in a direction of pulling of the cable 2. If necessary, a reinforcement is placed on the displaced portion of the element 1, the thusly installed reinforcement is connected with the armature of the previously installed piece pipe in a known manner, and pour concrete on the thusly obtained portion.

In accordance with another embodiment of the present invention, the element 1 with the cable 2 is arranged in the previously dug trench 3 on supports 5. The supports 5 are necessary for lifting the element 1 in order to place an armature under the element 1 if necessary. The subsequent steps correspond to the steps in the method in accordance with the first embodiment. In other words, by turning the element 1 from inside out every time, it is possible to produce an uninterrupted joint-free pipeline.

After laying of the pipeline, the previously dug trench 3 is closed by pouring material into it.

It will be understood that each of the elements described above, or two or more together, may also find a useful application in other types of methods and constructions differing from the type described above.

While the invention has been illustrated and described as embodied in a method of constructing pipelines of large diameter in an area of laying a device for the method, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method of producing a concrete pipeline in an area where the pipeline is to be laid, comprising the steps of making a trench; installing in the trench a cylindrical elastic element with a diameter equal to an inner diameter of the pipeline to be laid' placing armature on said cylindrical elastic element; pouring a liquid concrete solution on said element with said armature and hardening the concrete solution; after the hardening of the concrete solution turning a part of said element inside out; placing a reinforcing on a thusly obtained portion of said element with turned part; pouring a concrete solution again onto said portion of said element with said armature.

2. A method as defined in claim 1; and further comprising placing along an axial line of said element a cable formed as a closed cable.

3. A method as defined in claim 1; and further comprising placing along an axial line of said element a cable formed as an open cable whose length is increasable.

4. A cylindrical elastic element for making a concrete pipeline and installable and a trench, wherein said cylindrical elastic element has a diameter selected to be equal to an inner diameter of the pipeline to be laid and is provided with an armature on it, with concrete produced by hardening of a liquid concrete solution poured on the element with the armature, with a part of the element with the armature turned inside out, with an armature on a portion of the element formed this way, and with a concrete produced by pouring of a concrete solution on said portion of said element with the armature.

5. A cylindrical elastic element as defined in claim 4; and further comprising a closed cable arranged along the axial line of the element.

6. A cylindrical element as defined in claim 4; and further comprising a cable arranged along an axial line of the element and having a length which is increasable.
